(19) United States
(12) Patent Application Publication
(10) Pub. No.: US 2008/0086961 A1
(43) Pub. Date: Apr. 17, 2008

(54) Frame for a Door, a Window, or the Like

(76) Inventor: Josef Westermann, Steinfeld (DE)

Correspondence Address: GUDRUN E. HUCKETT DRAUDT, SCHUBERTSTR. 15A, WUPPERTAL, 42289, omitted

(21) Appl. No.: 11/576,715

(22) PCT Filed: Oct. 6, 2005
(86) PCT No.: PCT/EP05/10771

§ 371 Date: Jan. 4, 2008

(30) Foreign Application Priority Data
Oct. 9, 2004 (DE) 10 2004 049 334.0
Sep. 12, 2005 (DE) 10 2005 043 199.2

(51) Int. Cl. E06B 7/00

(52) U.S. Cl. 52/204.593

(57) ABSTRACT

A frame for a window, a door or a similar facade element as a casement frame or wing frame has a profiled frame section. The frame has an interior side and an exterior side. Attachment profiled sections are provided, wherein a first one of the attachment profiled sections is arranged on the profiled frame section on the interior side and a second one of the attachment profiled section is arranged on the profiled frame section on the exterior side. At least the second attachment profiled section is secured on the profiled frame section so as to be positionally adjustable for compensation of thermal length changes and is removable from the profiled frame section.

The invention relates to a frame for a window, a door or a similar facade element, that is configured as a casement frame or wing frame and comprises at least one profiled frame section.

Conventional frames for windows, doors or similar facade elements have the problem that only certain material combinations can be used as a result of different length expansion of the employed materials.

The present invention has the object to solve this problem and to provide an improved frame with broadened utilization range for use in connection with doors, windows, or similar facade elements.

The object is solved for a frame of the aforementioned kind, the frame having a profiled frame section that serves as a support for at least two attachment profiled sections wherein one is arranged on the interior side and the other on the exterior side. At least the exterior attachment profiled section is securable on and removable from the profiled frame section to allow positional adjustment for compensation of thermal length changes of the employed profiled sections. The attachment profiled sections as well as the basic profiled frame section are therefore accessible for servicing; likewise, because of the removability of the attachment profiled sections, an exchange of windowpanes is possible, for example, without destruction of the profiled frame sections in the case of a window provided with the frame according to the invention.

As a result of the thermal break of such a composite construction according to the invention, it is thus possible to employ materials that otherwise are unsuitable for window construction; the same holds true also for the surface treatment, for example, lamination of the frame.

Advantageously, attachment profiled sections of a material different than that of the profiled frame section itself can be attached externally to the profiled frame section; this makes the frame visually adaptable in many ways. Instead of using different materials with different thermal length expansion properties, the different expansion behavior can be of course also the result of different surface treatment of identical materials.

It is within the gist of the invention to configure the profiled frame section as a hollow profiled section that is produced preferably of plastic material. Alternatively, the profiled frame section can also be monolithic, i.e., can be comprised essentially of one material without cavities, for example, embodied as a solid wooden profiled frame section.

Particularly advantageous is the attachment of an attachment profiled section, in particular, an exterior one, by means of an external stay that extends essentially across the length of the profiled frame section. This type of attachment ensures a torsion-free mounting and an excellent positional adjustability in the case of thermal length expansion of the attachment profiled section. Instead of the stay, other attachment means are conceivable that extend essentially continuously across the length of the profiled frame section that is advantageously embodied as a hollow profiled section. The advantage of these attachment means, for example, in the case of attachment profiled strips embodied as glass securing strips, is the uniform pressure applied by the glass securing strip on the glass so that a sealing contact relative to the glass is ensured across the entire length of the profiled section. The stays or attachment means can be interrupted by short cuts without this causing a deterioration of the fixation of the windowpane caused by the pressure applied by the profiled section.

In another window frame according to the invention, it is provided that on the interior side cover strips or attachment profiled sections of materials are used, for example, noble wood, that are unsuitable for use in window construction because of costs, constructive consideration or other reasons.

The attachment profiled sections with their securing action according to the invention can be used when reinforced also as a reinforcement, for example, for bullet-proof windows. These attachment profiled sections as well as other attachment profiled sections can be of a multi-layer configuration or monolithic, i.e., can be comprised essentially of a single material without cavities and of a compact structure.

Especially advantageous is moreover a composite construction according to the invention in which a support profiled section, an exterior attachment profiled section and an interior attachment profiled section are made of different materials. For example, the interior attachment profiled section can be comprised of a wooden shell, the central support profiled section can be made of plastic material, and the exterior attachment profiled section can be made optionally of a different plastic material or of metal. In this way, resources are spared and the interior plastic profiled section that serves as a support profiled section is excellently shapeable for different applications. Such a composite construction is shape-stable in any weather situation and is torsion-free as a result of the positionally adjustable expansion possibilities of the employed materials and is thus different from only spot-fixed, for example, screwed or partially glued, profiled sections.

In a further advantageous configuration of the invention, it is provided that the frame has a web that is configured as a springy twin web for connection of profiled frame section and exterior attachment profiled section wherein this connecting web can secure the exterior attachment profiled section with pretension. Such a springy twin web takes care of the length expansion in different ways. On the one hand, the locking action or snap-on action of an attachment profiled section on the springy twin web that extends in the longitudinal direction of the attachment profiled section leads to the possibility of a positionally adjustable attachment. On the other hand, the two springy webs of the springy twin web are tensioned toward one another or away from one another upon attachment or snap-on action of the attachment profiled section so that, dependent of the stability of the springy webs, they provide toward one another or away from one another a certain securing pretension. This leads to a fixed or lasting attachment of the attachment profiled section and profiled frame section wherein the positional adjust ability is however not limited. Depending on the required pretension, the webs are to be configured accordingly thicker or thinner and, optionally, so as to project by different amounts, wherein because of the removability that must be ensured the springy webs must be configured to be elastic enough. A reversible removability and thus an exchange of the attachment profiled sections are ensured only by means of the elasticity of the springy webs. Advantageously, by means of different wedge configurations of the two springy webs an improved adaptability to attachment profiled sections is provided also.

It is also possible that, instead of arranging the springy twin webs on the profiled frame section, the webs can be arranged on the attachment profiled section and can engage corresponding contact areas of the profiled frame section.

Advantageously the springy twin webs have at least one nose-shaped contact area that secures the attachment profiled section in a torsion-resistant way. This nose-shaped contact area, engaged from behind by the attachment profiled section or the hollow profiled section depending on the side where the springy twin web is secured, prevents torsion of the attachment profiled section transverse to its longitudinal extension and thus prevents detachment of the snap-on profiled section. Because the longitudinal change of the attachment profiled section is realized along the contact areas and friction is generated thereat, the surface of these contact areas is small in comparison to the surface area of the attachment profiled section.

Advantageously, the interior attachment profiled section is clamped in locking webs that enable a simple type of attachment of the interior attachment profiled section on the hollow support profiled section and also, if needed, a simple removal or an exchange of the interior attachment profiled section.

In order to reinforce the frame and also to secure it against break-in, a further embodiment of the invention provides the introduction of metal, glass-fiber reinforced plastic or other reinforcements in cavities of the profiled frame sections.

In the end areas of these cavities that extend along the main extension of the frame, it is advantageous to provide some space between the cavity and the metal reinforcement because the metal reinforcement may possibly thermally expand differently than the profiled frame section when comprised of a different material.

At least three sealing planes and thus concurrently two rabbet sealing chambers ensure an especially good thermal insulation of the frame according to the invention when it is used in connection with a window.

Further advantages and details of the invention result from the schematic illustrations of the invention explained in the following. The drawings show in:

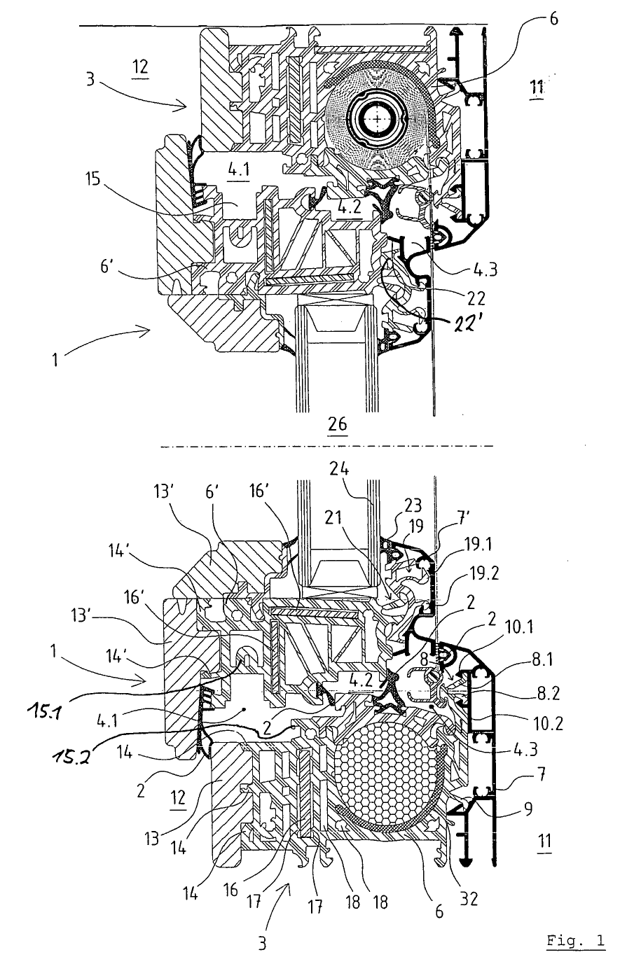

FIG. 1 a vertical section of a window with a casement frame according to the invention and a wing frame according to the invention;

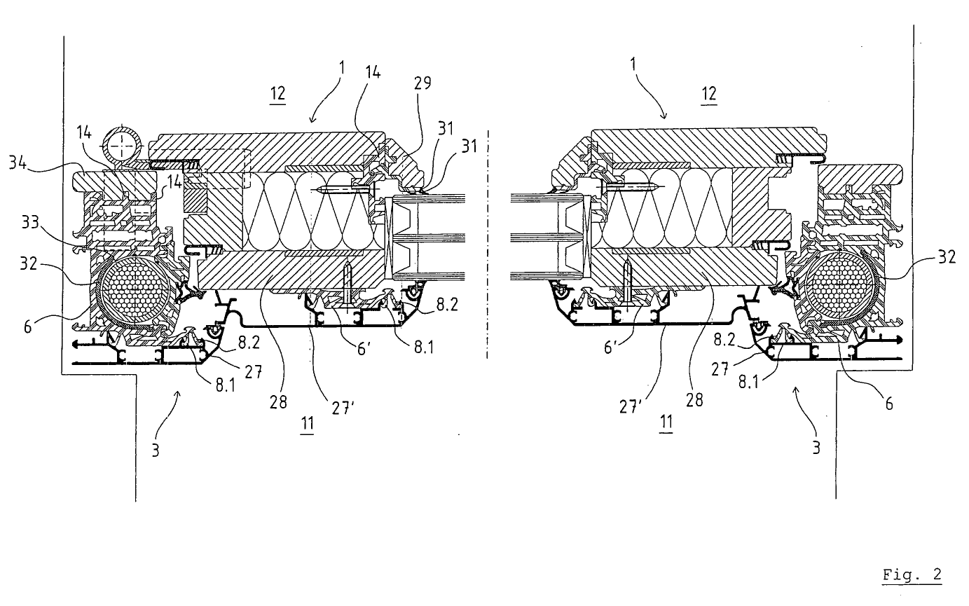

FIG. 2 a horizontal section of a door with a casement frame according to the invention and a wing frame according to the invention;

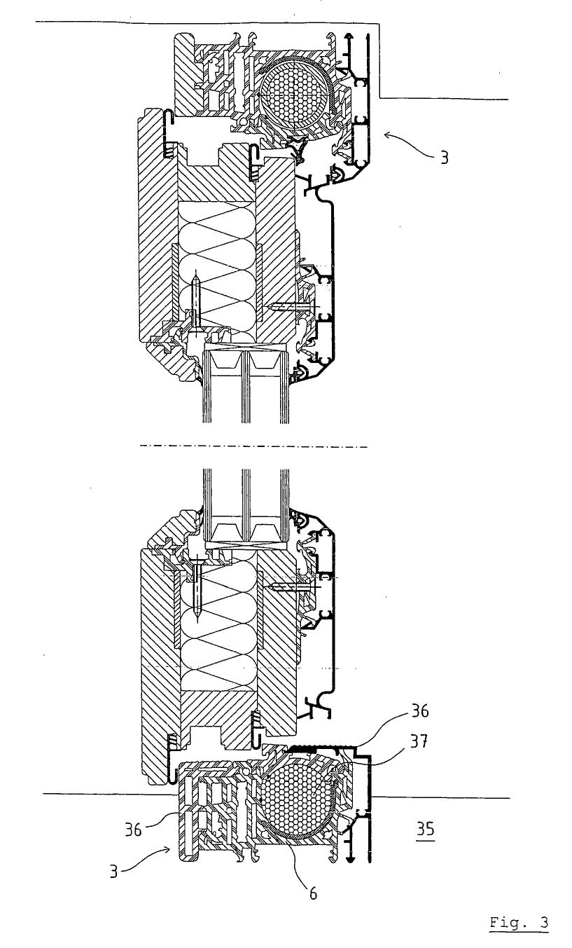

FIG. 3 the object according to FIG. 2 in vertical section;

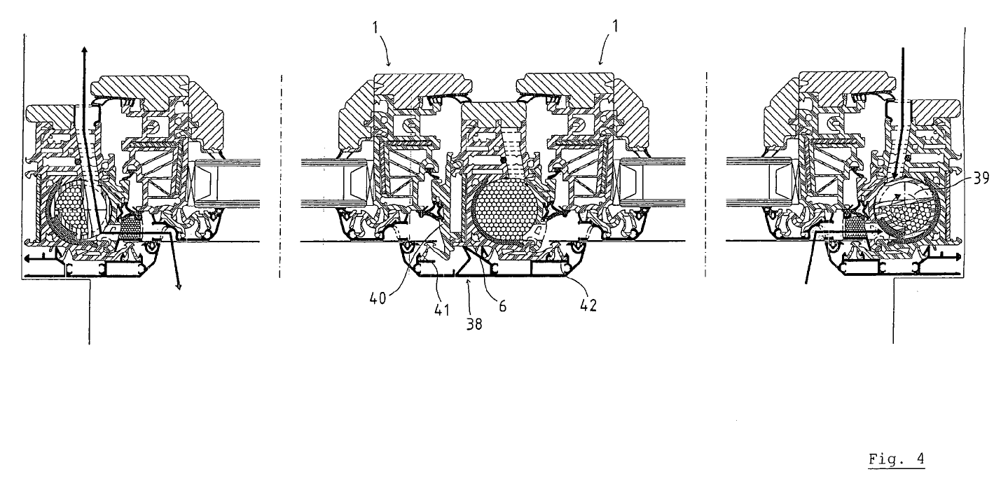

FIG. 4 a horizontal section of a window embodied with a center post and having a frame according to the invention;

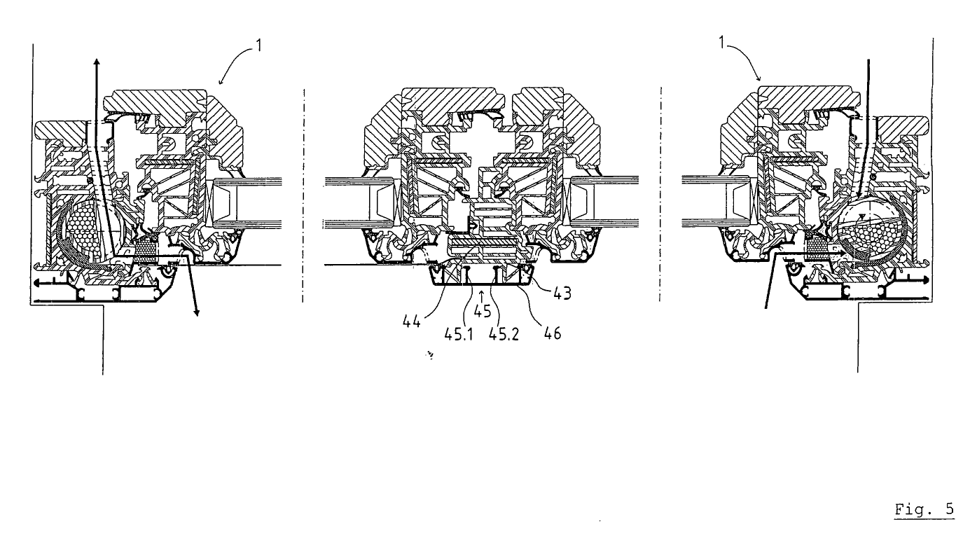

FIG. 5 a horizontal section of a window embodied without center post but with a locked releasable wing, provided with a frame according to the invention;

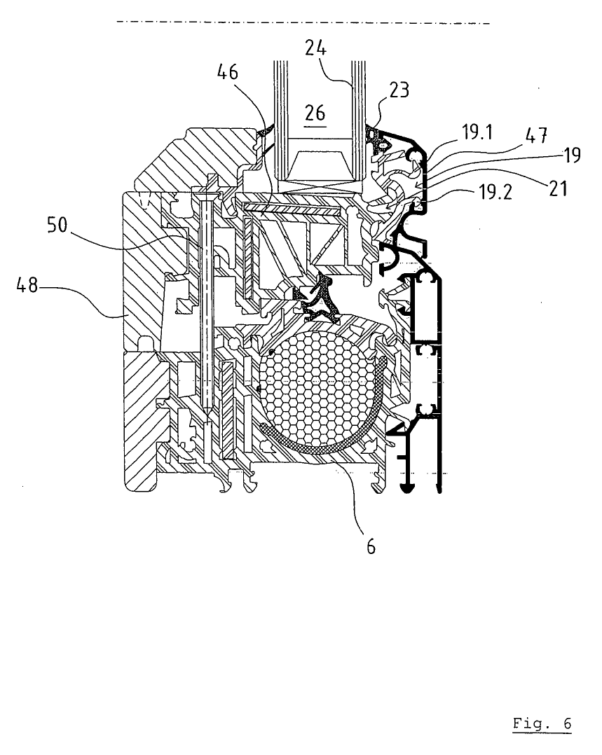

FIG. 6 a vertical section of a further casement frame according to the invention, the casement frame being doubled for a fixed windowpane;

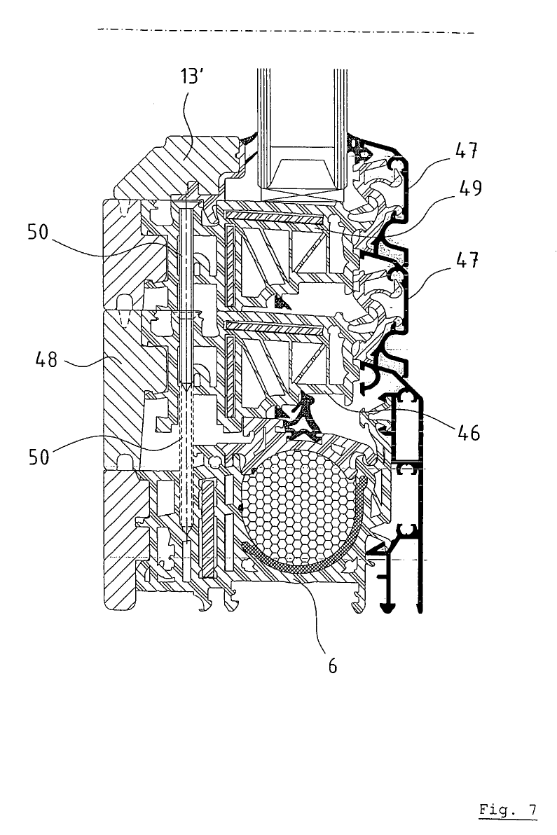

FIG. 7 a vertical section of a further frame according to the invention with a casement frame that is doubled for a fixed windowpane;

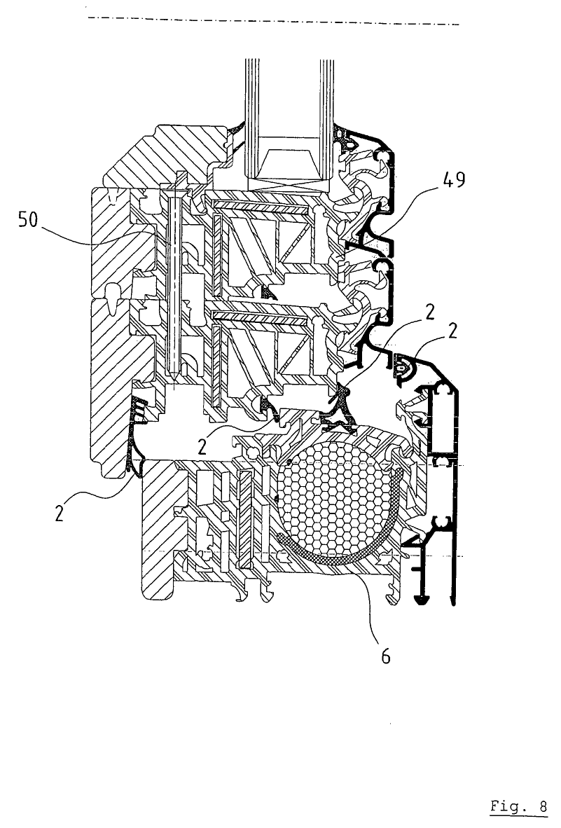

FIG. 8 a vertical section of a casement frame and wing with the wing being doubled;

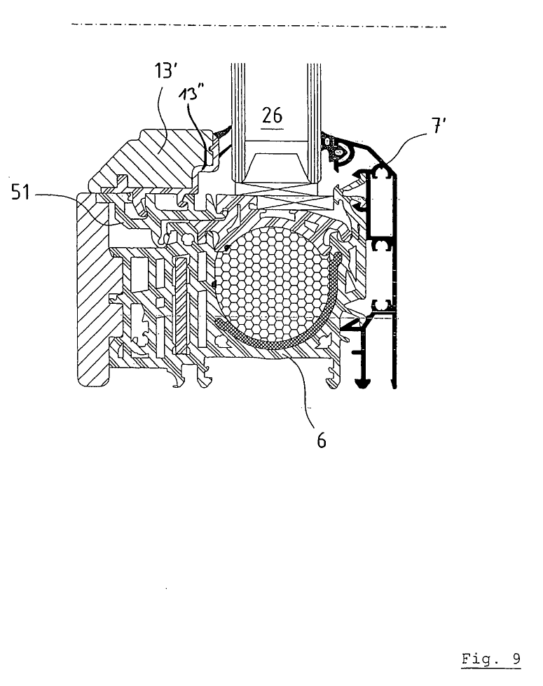

FIG. 9 a casement frame for a fixed windowpane;

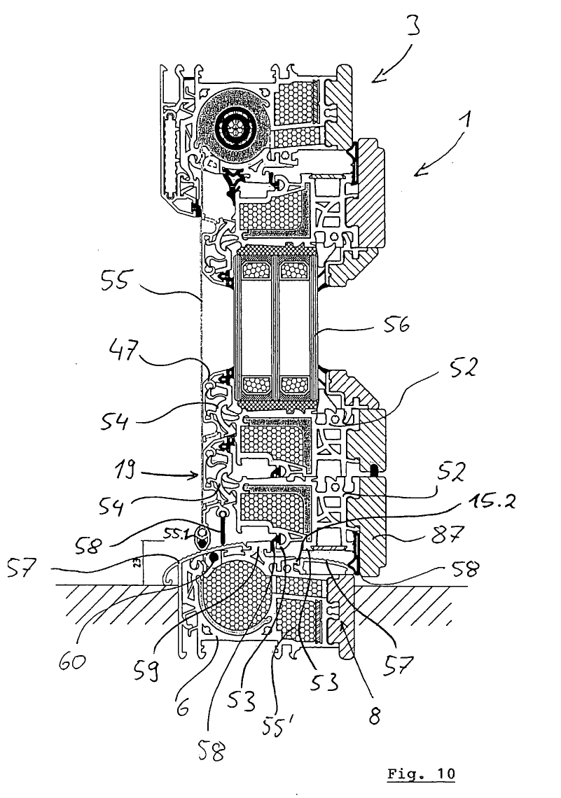

FIG. 10 a vertical section of a further embodiment of a door equipped with a casement frame according to the invention and a wing frame according to the invention;

FIG. 11 a vertical section of a further embodiment of a casement frame according to the invention with a rotatable venting tube, similar to FIG. 4;

FIGS. 12 to 17 vertical sections of further embodiments of a casement frame according to the invention with different connections of a window sill;

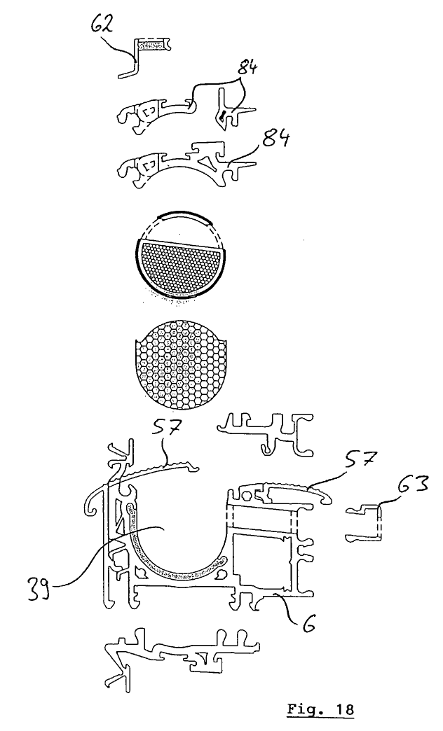

FIG. 18 an exploded view of a hollow profiled section for a casement frame in vertical section of a frame according to the invention, showing a plurality of adapters to be attachable thereto;

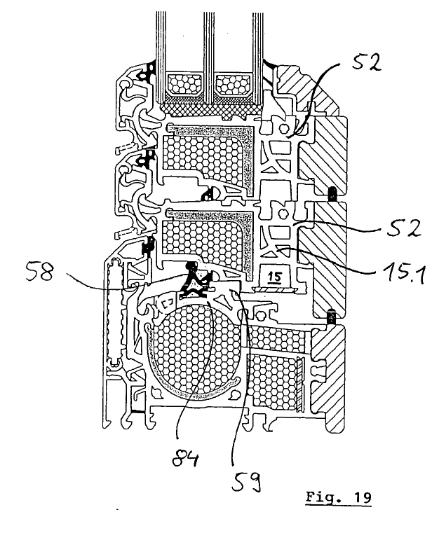

FIG. 19 a vertical section of a further frame according to the invention being doubled for a fixed windowpane;

FIG. 20 a vertical section of a frame according to the invention of a patio door having a wing frame that is doubled;

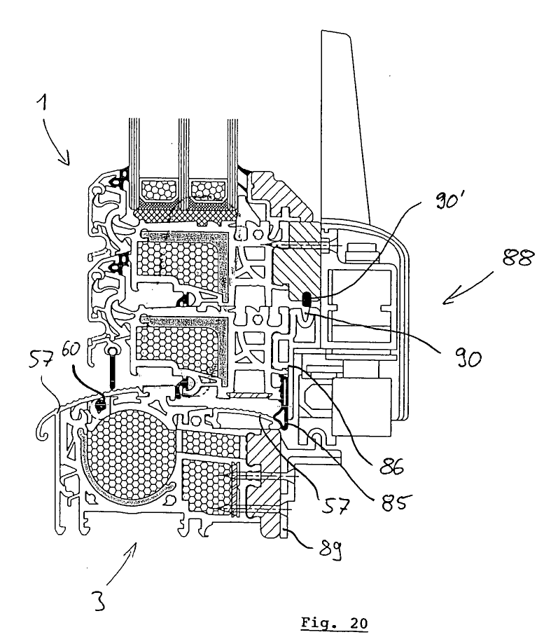

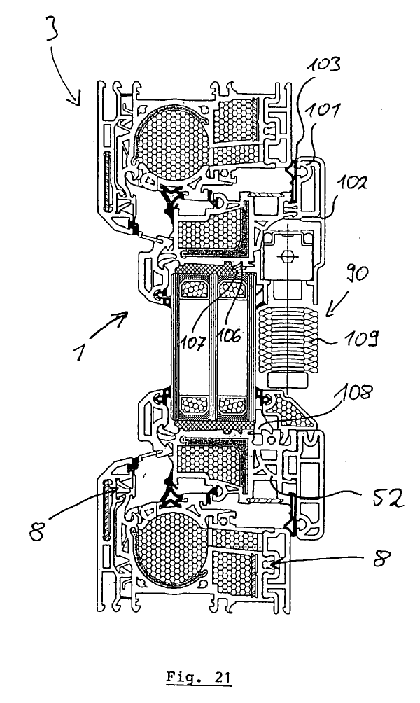

FIG. 21 a vertical section of a frame according to the invention with a shade element mounted on the interior side of the wing;

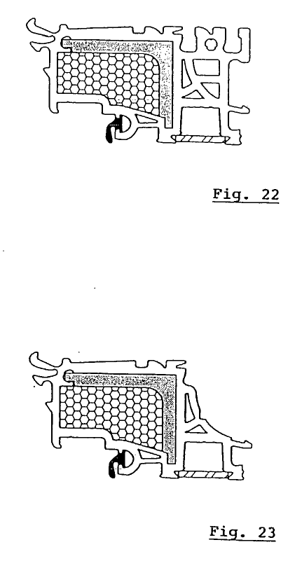

FIG. 22 a section of a hollow profiled section that is the basis of a wing frame according to the invention;

FIG. 23 the object of FIG. 22 with an area that has been milled off for arranging an interior shade element thereat;

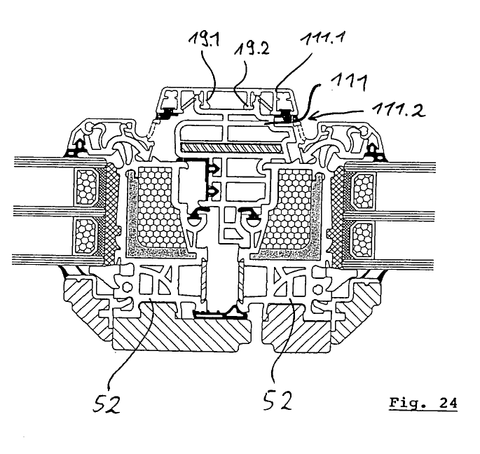

FIG. 24 a horizontal section of a wing frame embodied as a locked releasable wing;

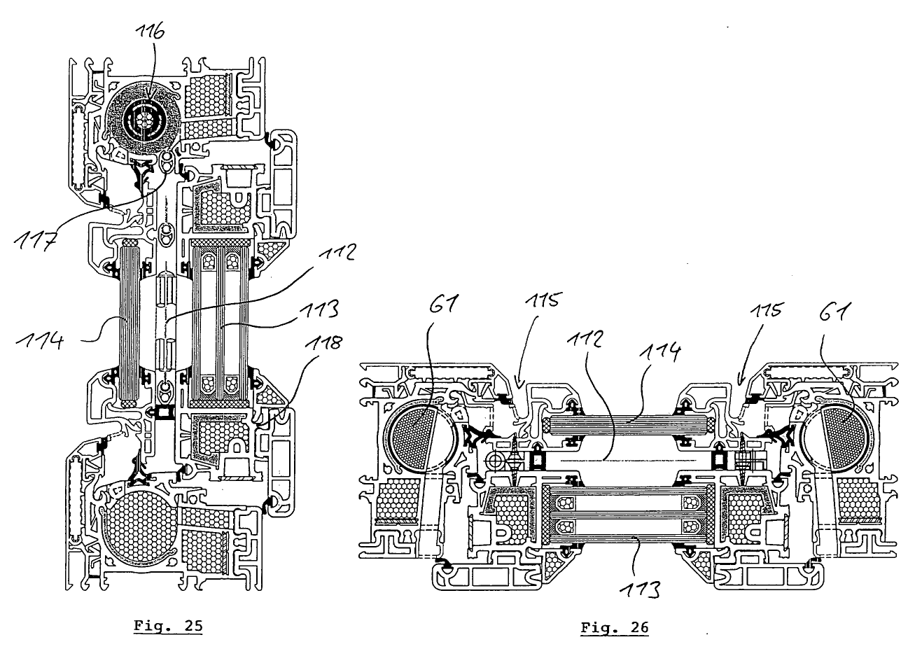

FIG. 25 a vertical section of a composite wing window with a frame according to the invention;

FIG. 26 a horizontal section of the object according to FIG. 25;

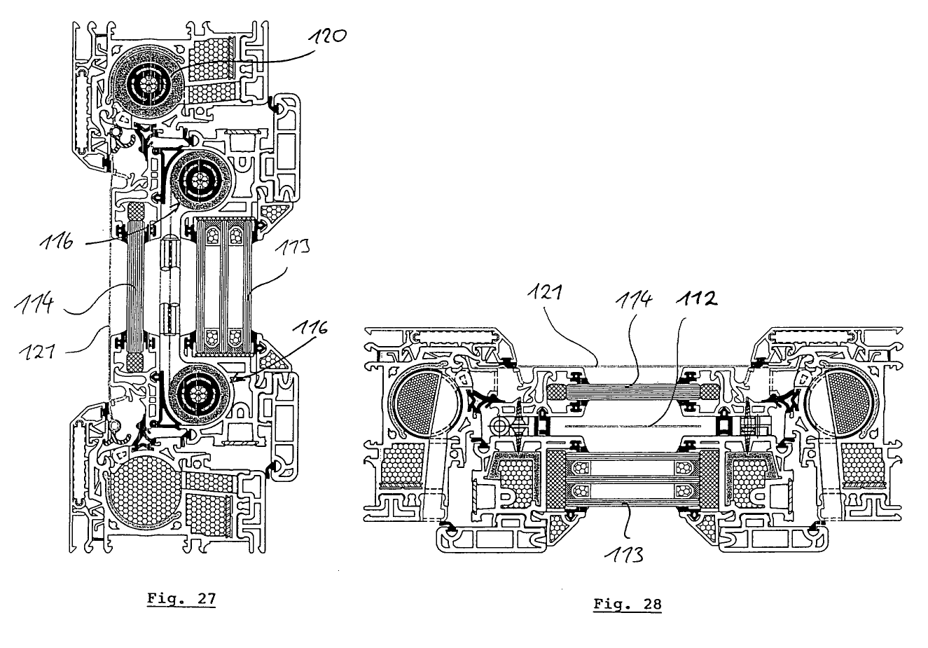

FIG. 27 a vertical section of a further composite wing window with a frame according to the invention;

FIG. 28 the object of FIG. 27 in horizontal section;

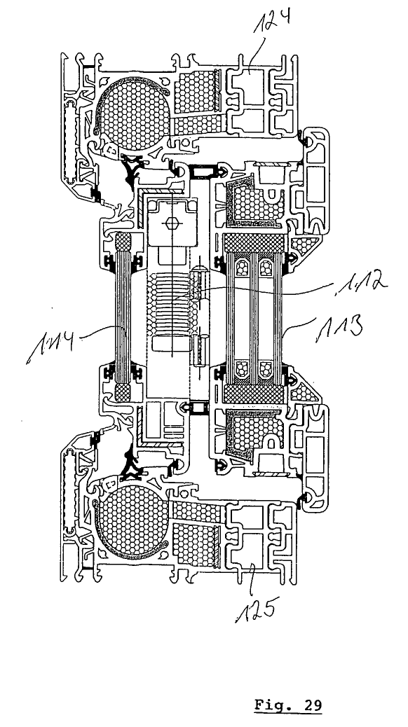

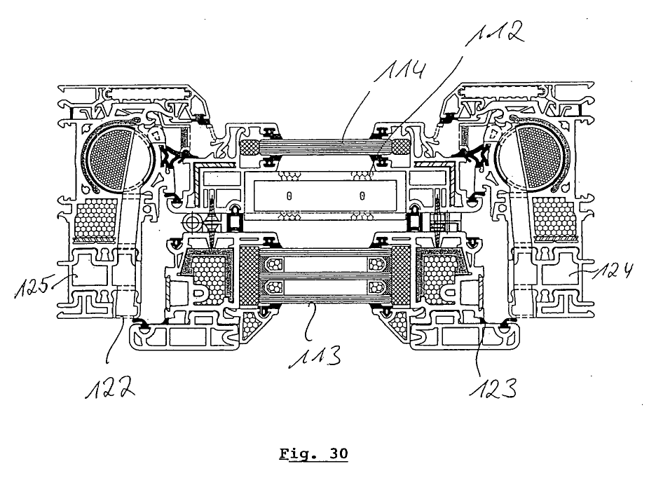

FIG. 29 in a representation analog to FIG. 27 an alternative embodiment of a composite wing window with a blind element between the glass panes;

FIG. 30 the object according to FIG. 27 in horizontal section.

A composite construction illustrated in FIG. 1 discloses two frames according to the invention that form part of a window. The window is in the closed position in which a wing frame 1 is connected by seals 2 with the casement frame 3. The configuration of a total of three inwardly positioned rabbet seal chambers 4.1, 4.2, and 4.3 and accordingly four sealing planes leads as a result of the greatly reduced convection to a very good thermal transmittance U of the window provided with a frame according to the invention. This thermal transmittance U depends on the used materials and in the illustrated embodiment is approximately 0.8, wherein thermal transmittance suitable for a so-called passive house are achievable. Moreover, an excellent sound proofing is achieved.

Additionally, the use of a seal 2 that is inwardly positioned in the lower frame area of a window and arranged elevated on the casement frame 3 leads to advantages in regard to a controlled water guiding action because the water that has entered through openings into the outer sealing area 4.3 preferably is located below the seal 2 and therefore cannot reach the critical area of the interface between the wing frame 1 and the casement frame 3. The water that is present within the sealing area 4.3 can therefore drain unimpededly through openings.

A profiled frame section embodied as a hollow (support) profiled section 6 of the casement frame 3 or 6′ of the wing frame 1 is configured as a PVC profiled section. Instead of a PVC profiled section, other profiled sections made from other weldable or non-weldable plastic materials can be used. On the exterior, on the casement frame 6 an attachment profiled section 7 of aluminum is arranged so as to be positionally adjustable. This aluminum profiled section is secured essentially by springy webs 8.1 and 8.2 of the hollow profiled section 6. In addition to these springy twin webs 8 a single springy web 9 is provided for securing the outer attachment profiled section 7 on the hollow profiled section 6. The springy webs 8.1 and 8.2 of the springy twin webs 8 are slightly elastic, due to the employed PVC material and due to their shape, and lock in place in complementary undercuts 10.1 and 10.2 of the attachment profiled section 7. Accordingly, the attachment profiled section 7 on the exterior side 11 is attached with pretension so as to positionally adjustable and in particular slidable and, by using an additional springy web 9, snapped on securely. The thermal length expansion of the different materials, in particular the length expansion of the exterior attachment profiled section 7 relative to the hollow profiled section 6 can thus occur without impairment and the hollow profiled section 6 behaves substantially neutral with regard to thermal loads of the exterior attachment profiled section 7.

The profiled section of the casement frame according to FIG. 21 moreover has a further twin springy stay 8 with which an interior attachment profiled section of plastic material can be detachably secured.

This, in turn, makes it possible to rigidly clip on the interior side 12 an inner attachment profiled section 13, made from a different material, in the illustrated embodiment wood, in the locking webs 14 of the hollow profiled section 6.

Several identically referenced cavities 18 improve moreover the insulation effect of the casement frame 3 and enhance its rigidity while at the same time the amount of material is minimal.

The wing frame 1 with its composite construction is essentially identical to the casement frame 3. On the interior side 12, attachment profiled sections 13′ made from identical material, in this case wood, are inserted between the locking webs 14′.

Metal reinforcements 16′ reinforce the wing frame 1. Viewed from the exterior side 11, the fitting groove 15, whose rear wall is reinforced for a safe attachment of the fitting with at least one projection 15.1, is located not only in an area that is protected by seals 2 from water but is also additionally secured by metal reinforcements 16′.

The width of the chamber that is arranged behind the fitting groove and is used for receiving the actuator housing is limited to the exterior size of the actuator housing. The actuator is thus secured in a torsion-resistant way and cannot wiggle or break apart, which can happen in the case in conventional actuator chambers.

Since in particular one of the central sealing planes is configured as a circumferentially extending sealing plane, the fitting is safely protected from water. The width of the fitting groove 15 is limited to the outer size of the actuator so that the actuator housing cannot break apart which can happen in the case of the usually large chamber configurations of prior art plastic or aluminum windows.

On the exterior side, an attachment profiled section 7′ of aluminum is secured by means of two springy webs 19.1 and 19.2 of a twin web 19. In contrast to the springy twin web 8 of the casement frame 3 the twin web 19 is however not located on the hollow profiled section 6′ but is connected as a thermal break by means of an additional (twin web) profiled socket 21 essentially to the hollow profiled section 6′. The springy twin web 19 is thus part of an adapter that serves for securing the attachment profiled section 7′ embodied as a glass securing strip. The web 22 of the attachment profiled section 7′ or a web 22′ of the adapter profiled section is clamped against the hollow profiled section 6′ only in one area when the window pane is forced in. The attachment profiled section 7 can move freely, without automatically becoming detached, within the hollow profiled section 6′ corner-welded to form the frame. However, by means of windowpane seals 23 a seal-tight connection to the glass 24 of the windowpane 26 across the entire length is ensured. In this area the removability of the attachment profiled section 7′ is also provided by means of an object that is to be extended through the seal 23 and that is to push away a springy web of the springy twin web 21. The lower second twin web 22′ of the twin web profiled socket 21 is not needed as an opposing load for the glass pressure load. It serves only for fixation and longitudinal lateral guiding of the adapter profiled section.

The door illustrated in FIG. 2 is also manufactured with the frame according to the invention in composite construction. The casement frame 3 of the door as well as the wing frame 1 are comprised essentially of three different materials wherein the exterior aluminum profiled section 27 or 27′ is secured so as to be positionally adjustable by means of the springy twin webs 8.1 and 8.2 on the support profiled section 6 or 6′ made of PVC. These springy twin webs 8.1 and 8.2 extend with their length across the entire length of the respective profiled frame section. As in the following embodiments, the profiled frame section is a hollow profiled section.

The part of the hollow profiled section 6 identified in FIG. 2 by 6′ is a modified, i.e., cut-off shape, of the hollow profiled section 6 that is secured on the part 28 of the door comprised of wood. The basic hollow profiled section 6 can thus also be used for constructing the wing frame 1, if needed. On the interior side 12 rigid wood profiled sections 29 are attached again in a self-locking action as glass securing strips wherein sealing lips 31 seal off the profiled section 29 relative to the glass. Rounded glass-fiber plastic inserts 32 that surround partially a round steel 33 inserted into the hollow chamber of the hollow profiled section 6 and that are replaceable by other stabilizing materials serve, in addition to the round steel, for providing the required stability of the PVC profiled section and are used also in the window frame described in connection with FIG. 1. The round steel 33 takes care of the increased requirements with regard to static needed in connection with doors On the interior side of the casement frame 3, in a similar way as in FIG. 1, a further attachment profiled section 34 made of wood is secured in the locking webs 14 of the hollow profiled section 6.

The door according to FIG. 2 is configured to be suitable for disabled persons (FIG. 3). For this purpose, the hollow profiled section 6 of the casement frame 3 according to the invention is partially cut away and has in its lower area close to the floor 35 attached profiled cover sections 36 that are resistant to foot traffic. The lower hollow profiled section is filled with insulation material 37. As a result of the plastic trim 2′ in the area of the casement frame 3 that is part of the hollow profiled section 6, this door can thus be used as a door for disabled persons. By exchanging the profiled section 36 of the casement frame 3 for an also foot traffic-resistant profiled section abutting the profiled section part 2′, the door can also be configured as a barrier-free door without disruptive edge wherein for this purpose the wooden profiled sections 36.2 and 36.3 are optionally to be configured differently. For sealing the interior relative to the exterior, for example, a brush strip can be arranged on the casement frame 3 for sealing the door.

The profiled edge 2′ of the casement frame serves in particular for configuring a circumferentially extending central sealing plane, or a stop for a seal 2, wherein the frame of the door sill together with the jambs of the door are welded at the corners or, for example, mechanically connected by creasing. Two circumferentially extending sealing planes lead to the configuration of a rabbet sealing chamber beneficial for thermal insulation.

The frame according to the invention can be provided partially with a center post 38 (FIG. 4) wherein a part of a cavity 39 is filled with an insulating material 37. The shape of the basic hollow profiled section 6 of the center post filled with insulating material 37 corresponds essentially to the hollow profiled section 6 on the frame sides, as disclosed in connection with FIG. 2. In addition, however, the central part of the casement frame 3 is configured by means of additional profiled sections as a center post 38 as a stop for the wing frame 1.

Advantageously, the hollow profiled section 6 with its cavity 38, because of its configuration as a platform profiled section, can also be used for more complex window shapes. In particular, as a result of the attachment of a profiled part 40 that is provided in the illustrated embodiment with an identical stop for the wing frame 1 and that comprises a stay 41 corresponding to a stay 42 of the basic hollow profiled section 4, the hollow profiled section 6 is embodied in the area between the lateral parts of the casement frame 3 as a center post with contact possibilities for the wing frame 1. The configuration of a correlated locking member matches that of the configuration of the center post.

According to FIG. 5, the contacting parts of the two-part wing frame 1 that touch one another can be configured also like a locked releasable wing frame wherein an additional profiled section 43, also provided with a reinforcement 44, can be attached to a part of the wing frame 1. This additional profiled section 43 is provided on its exterior by means of a springy twin web 45 with springy webs 45.1 and 45.2 with an external profiled section 46. This external profiled section 43 is thus secured to be positionally adjustable.

The attachment strips of aluminum or other materials are usually mitered and can be, for example, connected with one another by creasing. Alternatively, it is also possible to introduce a plastic profiled section into the aluminum profiled section, respectively, and to then fuse them with one another such that based on the melting loss the aluminum profiled section directly rest against one another. For imitating a wooden profiled section, it is also possible to provide the attachment strips with a corresponding coating and to attach them in the corner areas of the frame such that they counter one another or abut one another at an obtuse angle in accordance with standard wooden window construction.

According to a further advantageous configuration of the invention, it is provided to connect a wing frame part directly to a casement frame, for example, by screw connections, and to employ in this connection essentially the identical profiled sections (FIG. 6). The hollow profiled section 46 is formed by cutting off an edge area of a hollow profiled section 6′ and is screwed to the hollow profiled section 6 in order to provide a fixed connection.

On the twin web profiled socket 21 a springy twin web 19 with springy webs 19.1 and 19.2 is attached on which an attachment profiled section 47 is attached so as to be positionally adjustable, which profiled section is made by cutting an edge off the attachment profiled section 7′. This attachment profiled section 47 is formed as a glass securing strip and ensures with the window pane seal 23 a seal-tight connection to the glass 24 of the windowpane 26. Because of the missing edges of the profiled sections 46 and 47 in comparison to similar profiled parts of the profiled sections 6′ and 7′, the two hollow profiled sections 46 and 47, relative to the position of the profiled sections 6′ and 6 of FIG. 1, are slightly moved relative to one another so that the window is more narrow. The attachment profiled section 48 that corresponds to the interior attachment profiled section 13′, also formed of wood in this embodiment, is in comparison to its corresponding part 13′ also milled in order to ensure a uniform interior side of the frame.

When making the wing frame wider according to FIG. 7, the known profiled sections of the preceding embodiments can be used. For example, on a hollow profiled section 6 a hollow profiled section 46 of the wing is attached with fastening means 50 on which, in turn, a further hollow profiled section 49 of the wing, produced by milling off stays of the hollow profiled section 46, is attached by means of fastening means 50. The exterior attachment profiled section 47 corresponds to that of FIG. 6 so that, based on the substantial identity of the parts of the frames according to the invention, a pluralilty of possible constructions is conceivable. Also, the interior attachment profiled sections can be produced from the afore described ones by milling.

By exchanging the interior glass securing strip 13′ for a profiled section of different dimensions it is also possible to attach thicker attachments in a safe way (see also FIG. 2 and FIG. 9).

It is also within the gist of the invention to double the window frame 6′ according to FIG. 1 with a profiled frame 49 in order to provide, in contrast to the object of FIG. 7, a window that can be opened (FIG. 8).

The embodiment according to FIG. 9 showing a fixed windowpane discloses a windowpane 26 that is directly arranged on the hollow profiled section 6 and is secured by two glass securing strips 13′ and 7′. In the same way as in the above described embodiments, the positionally adjustable attachment in accordance with the present invention of the attachment profiled section 7′ that provides at the same time the exterior cover as well as the self-locking glass securing strip 13′ provide for a dry windowpane installation, i.e., a windowpane installation with sealing profiled sections pressing against the glass and without any disruptive and wear-prone silicone seal.

Also, the removal of the windowpanes is possible without destruction wherein mounting and demounting can be done from the interior as well as the exterior of the room. In the end areas or corner areas, the exterior abutting attachment profiled sections 7′ can have, for example, a creased connection or a welded connection. The connection of the hollow profiled section 6 with the glass securing strip 13′ is realized by means of a matching attached auxiliary profiled section 51 that in this embodiment is made from PVC and provides the required locking plane for the attachment of the glass securing strip 13′ on the hollow profiled section 6.

Advantageously, the glass securing strip 13′ is formed of a combination of two elements. The glass securing strip support 13″ serves for locking the windowpane 26 at the hollow profiled section, at the same time a wooden shell is locked on the glass securing strip support 13′. By means of such a composite construction, on the one hand, an excellent securing action of the windowpane is ensured, and, on the other hand, the interior side of the frame is provided with a uniform visual appearance.

The present invention provides with a few basic profiled sections to be stocked a very flexible frame system for doors, windows, facade elements or the like. The basic profiled sections to be stocked can be adapted in a simple way, whether by milling off areas that are not required or by using adapter profiled sections, to different framing situations. In this connection, a plurality of profiled sections useable like a kit can be employed as a result of the identical locking situations. FIG. 10 shows a modification of the door according to FIG. 3. The upper cavity provided in the casement frame is in this case not filled with a foam material or insulation material but has a roller-type fly screen 55 which from the rolled-up position, not illustrated, can be moved into the position illustrated in FIG. 10. In both positions opening or closing of the door is not impaired. Advantageously, on the bottom end of the fly screen 55 in the area of an end strip 55.1 a magnetic or magnetizeable material is provided that interacts with a magnet holder 60 provided on the lower casement frame and in this way secures the fly screen in the closed position even when the door is open or in the case of wind. At the same time, the magnet of the magnet holder is not that strong that it would prevent a simple manual lateral sliding of the fly screen.

In contrast to the door illustrated in FIG. 3, the door according to FIG. 10 has a profiled section of the wing which in the lower area is formed by doubling two hollow profiled frame sections 52 with attached attachment profiled sections. Similar to the hollow profiled section 46 according to FIG. 6 the upper hollow profiled section 52 of FIG. 10 is missing milled-off areas 52 that are still present on the lower hollow profiled section 52. The hollow profiled sections 46 and 52 of the wing are essentially identical in their function. However, the profiled hollow section 52 has a further milled-off area (compare FIGS. 22 and 23) and therefore represents a modification of the profiled section 46. The glass securing strip 47 is again attached by means of an adapter profiled section 54 on the upper hollow profiled section 52 of the wing and is attached in the same way to the lower hollow profiled section 52 of the wing.

By using the adapter profiled section 54 with the springy twin web 19 or the springy twin webs 19 on the hollow profiled section 52 of the wing, on the one hand, the windowpane 56 of the door is safely attached and, on the other hand, the springy twin webs are configured elastically enough in order to enable, as needed, a simple replacement of the windowpane 56 without damaging the wing frame. As a result of the use of the elastic springy twin webs 19, the attachment profiled sections are detachably or removably arranged on the frame. This holds true for the wing frame 1 as well as for the corresponding secured attachment of the casement frame 3.

In contrast to the sill of the door according to FIG. 4, the door sill illustrated in FIG. 10 is provided with profiled sections 57 that are more strongly rounded and are arranged above a partially milled-off hollow profiled section 6 of the casement frame. As a result of its platform configuration the hollow profiled section 6 of the casement frame, despite the milled-off portion (compare e.g. FIG. 11) has still the attachment possibilities required for attaching the profiled section 57 of the sill. With a height of, for example, only 23 mm, this door is provided also with a door sill that is suitable for disabled persons. At the lower corner the doorframe is still seal-tight even in the case of thermally different length changes of the lower profiled elements of the casement frame because, according to the invention, a corner welding of the abutting frame sides can be provided.

The hollow profiled section 6 is slightly different but functionally identical to the hollow profiled section illustrated in FIG. 3. The cavity 39 in both Figures is filled with an insulation material. The hollow chamber shown in FIG. 3 serves like the chamber area 55′ according to FIG. 10 for insulation purposes. Moreover, the area identified at 55″ in FIG. 10, which area can serve in other configurations of the frame for venting purposes, is also filled with insulation material. Moreover, the stays for attachment of the attachment profiled section 36 according to FIG. 3 are configured partially as a springy twin web 8 for securing the wooden profiled section.

Advantageously, this door furthermore has at least three sealing planes that significantly increase the seal tightness of this door in comparison to other doors of the prior art. A central seal 58, arranged at the highest point of the door sill, i.e., the sill edge 59, as well as a further inwardly oriented seal 58 arranged at the edge area of the door (seal for the wing overlap) ensures good thermal insulation. Moreover, it is particularly advantageous that the profiled section 57 of the sill which is preferably made from metal, in particular aluminum is not continuous and therefore does not provide a thermal bridge between the interior and the exterior. Toward the exterior, a pendulous brush provides a first seal 58 with which coarse dirt and e.g. snow is kept away from the central seal 58. By means of this pendulous brush the stepping edge 59 that interrupts the aluminum profiled section is already arranged within a first insulated area. While water can still run off this first area, the area that is separated by the additional seals 58 is water-tightly and air-tightly sealed. Such a door according to the invention provides excellent thermal insulation values.

Advantageously, the door according to the invention is configured to be heatable in the lower hollow profiled section forming the doorsill as a function of a temperature sensor or manually in order to prevent freezing of individual sealing elements.

FIG. 11 illustrates the configuration of a hollow profiled section 6 of the casement frame according to the invention which, in this case, is provided with a rotatable venting tube 61 in the area of the cavity 39 similar to the embodiment of FIG. 4. By means of this venting tube 61 areas extending to the interior and to the exterior and formed by the hollow profiled section 6 and the profiled elements 27, 62, 63 are connected to one another for venting. In order to prevent that small animals, for example, insects, can enter the venting system, on the interior side and the exterior side protective screens 64, illustrated in dashed lines, are provided on the profiled sections 62, 63. Moreover, the illustrated frame according to the invention has a pollen filter 66, lateral roller screen guides 67 and a so-called Phonestop film 68 for providing soundproofing.

The frame according to the invention can be provided with an alarm device that triggers or generates an alarm signal when a break-in attempt is detected. In this connection it is advantageous to provide two electrical conductors, on the one hand an insect protection screen, on the other hand a contact element in the area of the central casement frame seal. When a break-in is attempted, usually the insect protection screen is pressed inwardly. The thus inevitably occurring contact with the contact element generates an electrical connection based on which the alarm device will triggers an alarm signal. Alternatively, the alarm device can also be a pressure sensor that monitors the pressure e.g. in the interior 69 of the seal 58 or in an area of the exterior seal and triggers the alarm signal when a pressure change occurs. For providing a direct defense in case of danger, it can be advantageous to supply by means of an electroshock device the frame at the time of registering an alarm signal at least partially with a high-voltage that will keep a burglar from making additional break-in attempts.

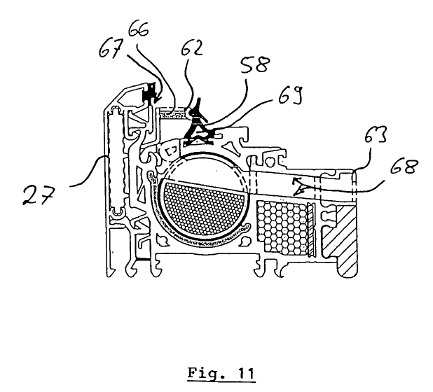

FIGS. 12 through 18 disclose different connecting possibilities of a frame according to the invention to different window sills. In FIG. 12 a vertical section is shown of a lower casement frame that has a receptacle for Z-profile window sills 71 as well as a connector for a standard window sill 72. This connection is replaced in FIG. 13 by an adapter profiled section 73 for a window sill. Moreover, adapter 74 provides a connection to a brick soldier course 76. By securing the adapter profiled section of the window sill on the wall, a good attachment of the frame is ensured also. In addition, the window sill connection can be sealed by a film 75, preferably a plastic film, that can be secured on the adapter profiled section 73 at different areas.

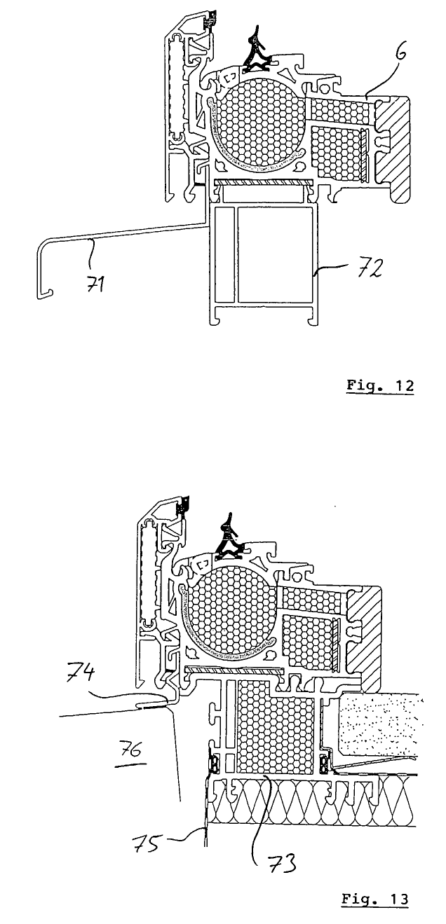

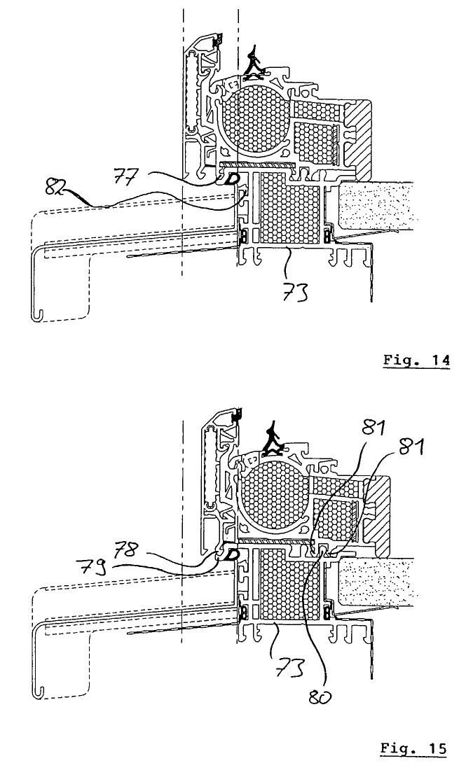

The casement frames according to the invention of FIGS. 14 and 15 show a window sill connection by means of the adapter profiled section 73 for a window sill already shown in FIG. 13, wherein in FIG. 15, by milling off a profiled stay 77, the entire casement frame can be displaced. A save securing action in the horizontal position is still ensured by means of the contact surfaces of the stays 78 and 79 or 80 and 81. The adapter stays 82 for the window sills provide different attachment possibilities for receiving standard aluminum window sills. By means of a plurality of different locking planes in the horizontal as well as vertical direction, the frame according to the invention is therefore adaptable to a variety of different window sill situations.

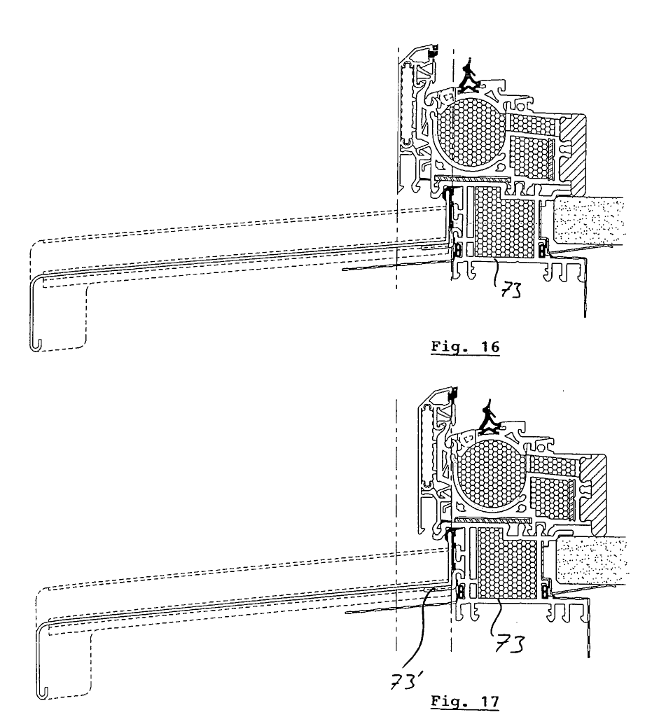

For window sills that have no attachment device, on the adapter profiled section 73 for the window sill, as shown in FIGS. 16 and 17, window sill supports 83 can be arranged. At the same time, the adapter profiled section for the window sill, inter alia by using correspondingly shaped supports 73′, can also be used as a mounting gauge for other window sill materials and shapes.

An excellent overview of the hollow profiled section 6 of the casement frame 3 and its different connecting possibilities or adaptation possibilities is illustrated in FIG. 18. By means of a basic profiled frame section 6 which is optionally partially milled off (compare FIGS. 15 and FIG. 10) a platform is therefore provided that can be adapted to different demands of window construction. This universality, i.e. the use of same parts in different situations of window construction, provides that the manufacture of a frame according to the invention is less expensive and simpler because only a few required parts must be manufacture and stocked. A cavity 39 that can be covered by a multi-purpose access cover 84 and forms a multifunctional chamber further increases the versatility of the frame according to the invention.

In the frame according to the invention shown in FIG. 19 a hollow profiled section of a casement frame is combined with two hollow profiled sections 52 of the wing to form a double-wide double pane window frame similar to the one shown in FIG. 7. The comparison of FIG. 10 (patio door) and FIG. 19 shows that essentially identical components are used and different functions are fulfilled by means of only a few changes and additions. For example, the central seal of FIG. 10 has been replaced by a seal of the cover strip 84 which forms the access cover 84. The corner of the cover strip 84 forming the stepping edge 59 is positioned flush against it as a result of milling off parts of the hollow profiled section 52 of the wing frame.

The door according to FIG. 10 which can be used, for example, as a patio door can be configured with only a few changes as a PST patio door. A further interior attachment profiled section 86 produced by milling an attachment profiled section replaces the profiled section 87 of FIG. 10 and serves as a contact surface and receptacle for the parallel-sliding and tilting mechanism 88 of the patio door. The parallel-sliding and tilting mechanism is therefore arranged in a cutout of the transverse wing member. At the same time, the attachment profiled section serves also as a pressing element for the interior sealing action of a seal 85 corresponding to seal 58. By means of the profiling of the profiled frame section and the locking stays of the overlap seal 85 engaging therein, the latter is arranged so as to be height-adjustable on the profiled section of the wing.

A rail guiding element 89 screwable in the area of the floor onto an interior profiled section, on which rail guiding element the sliding patio door can run, has only a minimal door sill height. This is so in particular because of the higher attachment of the rail guiding element 89 in accordance with the invention. In combination with a continuous cover rail with milled locking pin recesses that is recessed at the bottom in the fitting rabbet and is formed by the stepping rail 57, the door according to the invention is provided with a comfortable sill passage. The stepping rail 57 or the aluminum attachment profiled section can be provided according to another embodiment of the invention with milled recesses for different hook closures. Individual strike plates are therefore not needed. The risk of tripping is reduced. The cover or stepping rail 57 is snapped on by locking stay 15.2 and can be screwed on across its length to the casement frame. In this way, there results an increased pull-out resistance in comparison to individual covers known in the art. The frame according to the invention, when using same frame parts can therefore be used also for a PST door, in particular, with reduced sill height (for example, 28 mm).

In this type of door construction, the casement frame extends circumferentially and is configured with the same corner connections of the frame wherein a substantially greater corner joint strength results in comparison to conventionally used screw connections of the lower sill with the upright jambs. The upright jambs can then no longer laterally deviate from the sill when subjected to the hanging load of a possibly large and heavy wing. This holds true for all floor-length room-partitioning elements such as front doors, patio doors with rotating/tilting and rotating function, parallel-sliding and tilting doors (PST doors), folding doors etc.

Instead of mitered corner-welded joints, the interior shell of the wing frame facing the room according to a further advantageous embodiment of the invention can be butt-jointed at the corners. For this purpose, a groove 90 is provided that is engaged by a tongue formed by milling on a profiled frame section that is preferably provided at the interior side with wood appearance.

In an advantageous manner, the frame can provide the prerequisite, by milling the hollow profiled section of the wing to a predefined configuration, to arrange therein a shade element 90 in the frame at its interior side so as to be flush. In this way, the light passage is not impaired by head profiled section and shaft. This is enabled by exchanging the inner profiled shell for a special locking strip 101 and a cover strip 102 positioned on top. The cover strip 102 can be removed in a simple way for maintenance work. It can either end blunt (wood frame appearance) or can have a miter end. The circumferentially extending wing overlap seal 103 can be attached to different sealing heights, as needed. Variability and combination of different frame materials is possible at the interior side of the frame inter alia also by veneer-covered fake wood parts.

Within the thus defined cavity, slats 109 that are freely suspended and can be moved by a motor or by a cable pull, folded curtains or other room-darkening blinds or shade screens can be provided. It is also within the gist of the invention to arrange the shade screens not in the upper area of the wing but at its lower end in order to realize in this way the often desired screening from view at the lower end. An advertising roller blind can also be arranged at the interior side of the room so as to be vertically or horizontally movable.

By providing a special glass securing strip 104 it is also possible to provide a secure holding of the windowpane in the case of a milled-off hollow profiled section 46 of the wing. The special glass securing strip 104 has, on the one hand, a springy web 107 engaging a locking channel 106 of the basic profiled section of the wing and, on the other hand, it has a fixed contact point.

A further locking channel serves at the same time for fixation and support of the locking support socket 108 in order to provide an increased break-in protection. This socket 108 thus provides a pressure enhancing action for the glass securing strip.

The clamping of the windowpanes and of the panels is realized by means of exterior shells locked in place across their length as well as interior glass securing strips locked on the basic profiled section of the wing. The interior shell is not required.

The comparison of FIG. 23 with FIG. 22 shows the required milled-off part of the profiled section 46 of the wing for the attachment of an interior shading device. In this embodiment, the utilization of the attachment profiled sections already required in other embodiments of the hollow profiled sections or the casement frame is ensured so that not only the hollow profiled section 6 of the casement frame but also the hollow profiled section 46 of the wing can be stocked for a plurality of different applications. This kit-like or platform-like design of a frame system is not known in the prior art.

The hollow profiled section of the wing forms by attachment of a further attachment profiled section or locked wing profiled section 111, a locked releasable wing (FIG. 24). For this purpose, it is sufficient to attach the attachment profiled section 111; milling off portions as required in the prior art is not needed. The stop strip 111.1 that can be secured by springy webs 19.1 and 19.2 of a springy twin web is also removable. A guide 111.2 serves for guiding an insect screen and/or a shading element. Laterally, this guide 111.2 is delimited by a seal and a perforated web of the profiled section of the locked releasable wing.

A further configuration according to the invention of a frame is illustrated in FIGS. 25 and 26 showing a vertical section and a horizontal section of a composite wing window. The casement frame of the composite wing window has again a hollow profiled section 6 wherein however the access cover or cover strip 84 provided at the upper casement frame is designed slightly differently in order to ensure passage of a shading screen 112 that can pass between the two windowpanes through an open connecting gap between inner and outer wings 113, 114. In this connection, it is possible to actuate several hangings by means of a shaft 116, optionally by providing a shaft coupling, wherein only one drive is required. The composite wing window can advantageously have a safety feature by means of a sensor arranged in the area of the end strip 117 so that, in case the shading curtain or screen 112 is partially or entirely extended, it is impossible to open the window.

In FIGS. 29 and 30 one embodiment is shown in which by means of frame-side spacing elements 124 and 125 the spacing between the glass panes 113 and 114 is enlarged such that between them a shading device 112 in the form of a blind with individual slats can be arranged.

In FIG. 25 three possible stop positions of the end strip 117 are illustrated. Depending on its position, the end strip 117 in the case of strong wind loads acts as a spacer and prevents the exterior wing from being forced open.

In the illustrated embodiment of FIGS. 25 and 26 the hollow profiled section 118 of the wing of the triple-pane windowpane is different from the prior employed hollow profiled sections 46 of the wing. This is not necessarily required but can be expedient in this case in order to ensure an even better attachment of the exterior wing.

In the vertical exterior casement frame, venting tubes 61 are arranged which, as a function of their rotational position, enable venting of the interior room. This venting arrangement close to the rabbet chamber is arranged with its outwardly oriented areas laterally in a hidden groove of the wing frame and therefore, in contrast to the venting areas that are usually arranged to be a really visible on the wing frame or casement frame, is not detrimental in regard to the visual appearance of a uniform exterior surface.

As an alternative to the embodiment of FIGS. 25 and 26, the interior side of the wing frame can be provided with a shade shaft 116 which, however, because of the fact that, viewed in vertical section, it is located above the triple-pane windowpane 113, there is no impairment with regard to the total thickness of the wing and of the composite wing. The total thickness of the composite wing combination as well as of the casement frame, despite the shade shaft and the multi-pane (triple pane) windowpane in the interior wing is not changed relative to standard versions with one wing and is less than in conventional composite constructions.

Below the triple-plane windowpane 113 there is also a complementary shade shaft 116. A single screen 112 that by means of these two shade shafts 116 can run from top to bottom as well as from bottom to top can advantageously convey advertisement messages. It is also possible to effect transport of advertising messages from the left to the right or vice versa, for which purpose the shade shaft 116 is to be arranged in the lateral hollow profiled sections. For additional comfort, it is moreover possible to provide in the casement frame of the composite wing window also a cavity with a rotatable shaft 120 that then preferably supports an insect screen 121. The insect screen 121 is guided in the sides of the frame and can be locked by means of a locking strip at the end of the casement frame that is opposite the shaft. In one embodiment of the frame of plastic material, at 123 an additional sealing lip is formed by extrusion, as indicated in FIG. 28.

As a result of the identical profiling of the top and bottom casement frame, the roller blind can therefore also be replaced by an insect screen that simply locks at the top and bottom (and/or at the sides) when the insect screen has corresponding locking strips.

In the illustrated embodiment of a frame according to the invention, as in the preceding embodiments, an alarm sensor can be provided that advantageously cooperates with an electroshock generator operated by rechargeable battery and arranged within the lower casement frame and embedded in insulating material.

The electroshock generator, when triggered by the alarm sensor, supplies a current surge onto the entire outer aluminum shell and thus deters a break-in attempt.

As already described, in this embodiment the areas allowing passage of air can be lined with a sound proofing film that counteracts travel of sound.

As a whole, the afore described frame system provides a variety of possible window, door or other facade element constructions. Despite the plurality of combination possibilities, they can be realized with only a minimal number of parts. The window system or door system to be produced with the frame according to the invention can be stocked at minimal cost and is moreover also comparatively inexpensive.

What is claimed is:

1.-58. (canceled)

59. A frame for a window, a door or a similar facade element, the frame having an interior side and an exterior side and being configured as a casement frame or wing frame, the frame comprising a profiled frame section and attachment profiled sections, wherein a first one of the attachment profiled sections is arranged on the profiled frame section on the interior side of the frame and a second one of the attachment profiled section is arranged on the profiled frame section on the exterior side of the frame, wherein at least the second attachment profiled section is secured on the profiled frame section so as to be positionally adjustable for compensation of thermal length changes and is removable from the profiled frame section.

60. The frame according to claim 59, further comprising locking webs, wherein the first attachment profiled section is clamped in the locking webs.

61. The frame according to claim 59, wherein at least one of the attachment profiled sections is monolithic.

62. The frame according to claim 59, wherein the profiled frame section is a hollow profiled section that is configured by milling so as to be used in a doubled arrangement.

63. The frame according to claim 59, comprising a magnetic holder that secures in position a magnetic or magnetizable material arranged at an end of a shading or insect protection element.

64. The frame according to claim 59, further comprising at least one cover strip having an access opening for a closure element.

65. The frame according to claim 59, comprising an alarm device for detecting a break-in attempt.

66. The frame according to claim 65, wherein the alarm device comprises two frame parts arranged such that electrical contact between the two frame parts is established in a contact position, wherein in the contact position an alarm signal is triggered, wherein one of the frame parts is an insect protection screen and the other frame part is a contact arranged in the area of a main seal of the casement frame.

67. The frame according to claim 66, comprising an electroshock generating device that, as a function of the alarm signal, supplies the frame at least over areas thereof with voltage.

68. The frame according to claim 65, wherein the alarm device has a pressure sensor that monitors a pressure of a main seal of the casement frame and triggers an alarm signal when a pressure change is detected.

69. The frame according to claim 59, wherein the profiled frame section is a hollow profiled section that is configured to be adaptable in a kit-like fashion, by milling and/or at least one adapter profiled section, for use in a plurality of framing situations.

70. The frame according to claim 69, wherein on the interior side an area provided by milling is configured for receiving a shading element by employing at least one of the attachment profiled sections.

71. The frame according to claim 59, comprising a multifunctional chamber covered by an access cover.

72. The frame according to claim 71, wherein the access cover has at least one stop seal.

73. The frame according to claim 59, comprising a rail guiding element arranged elevated on the casement frame and a parallel-sliding and tilting mechanism arranged in a cutout of a transverse member of the wing frame.

74. The frame according to claim 59, wherein at least the first attachment profiled section is removable for servicing purposes.

75. The frame according to claim 59, having a composite wing construction comprising an interior wing and an exterior wing as well as a room-darkening and/or advertisement transport device movable between windowpanes.

76. The frame according to claim 75, wherein an end strip of the room-darkening and/or advertisement transport device is configured for supporting the exterior wing in case of exterior pressure load.

77. The frame according to claim 75, comprising a position sensor for determining a position of the room-darkening and/or advertising transport device.

78. The frame according to 75, wherein the room-darkening and/or advertising transport device is configured as a room-darkening and/or advertising transport screen.

79. The frame according to claim 75, wherein the room-darkening and/or advertising transport device is configured as an upwardly and downwardly movable screen element.

80. The frame according to claim 79, wherein, for storing the screen element between windowpanes, spacers for increasing a spacing between the windowpanes are provided.

81. The frame according to claim 77, comprising a closing mechanism operating as a function of the position sensor.

82. The frame according to claim 59, comprising a locking support socket that can be secured by at least one looking web of a hollow profiled section.

83. The frame according to claim 59, wherein a rear wall of a fitting groove is reinforced by at least one projection.

84. The frame according to claim 83, wherein a chamber adjoining the fitting groove is configured at least on lateral sides thereof so as to receive an actuator housing in a flush arrangement such that the actuator housing is secured to be torsion- resistant.

85. The frame according to claim 59, wherein a strike plate is secured on at least one locking stay.

86. The frame according to claim 59, comprising a glass securing strip that comprises a glass securing strip support for locking on a windowpane and further comprises a wooden shell locked on the glass securing strip support.

87. The frame according to claim 59, comprising a profiling suitable for insertion of an insect screen provided with locking strips.

88. The frame according to claim 59, comprising a profiling for height-displaceable receiving of an overlap seal that is provided with locking stays.

89. The frame according to claim 59, comprising a removable screen element for covering a venting area.

90. A window comprising a frame according to claim 59.

91. The window according to claim 90, wherein the frame comprises a locked releasable wing, further comprising a guide for a fly screen and/or a shading screen.

92. A door comprising a frame according to claim 59.

93. The door according to claim 92, comprising a cover strip that is attached to the profiled frame section and is resistant to foot traffic, wherein the cover strip embodies a stepping area, in particular a door sill that is suitable for disabled persons.

94. The door according to claim 93, wherein the cover strip is interrupted between the interior side and the exterior side for preventing a thermal bridge.

95. The door according to claim 94, wherein a lower frame configured as a door sill is laterally connected by welding or mechanically, in particular by creasing, to a vertical jamb.

96. The door according to claim 92 having at least one circumferential sealing plane.

97. The door according to claim 92 having two circumferential sealing planes for configuring a rabbet sealing chamber.
